(19) United States
(12) Patent Application Publication
(10) Pub. No.: US 2007/0146865 A1
(43) Pub. Date: Jun. 28, 2007

(54) Digital micromirror device and method of fabricating the same

(75) Inventor: Hee Baeg An, Seoul (KR)

Correspondence Address: MAYER, BROWN, ROWE & MAW LLP, 1909 K STREET, N.W., WASHINGTON, DC, 20006, US

(73) Assignee: Dongbu Electronics Co., Ltd.

(21) Appl. No.: 11/642,547

(22) Filed: Dec. 21, 2006

(30) Foreign Application Priority Data
Dec. 26, 2005 (KR) 10-2005-0129746

(51) Int. Cl. G02B 26/00

(52) U.S. Cl. 359/291

(57) ABSTRACT

A digital micromirror device has a substrate having a plurality of electrodes each spaced apart at a predetermined interval; fixed bases having a predetermined height above a surface of the substrate and arranged between the electrodes; and a plurality of micromirrors provided on the fixed bases and independently driven by an electrostatic force produced by the electrodes for changing a reflection path of incident light to form an image. The fixed bases comprise a material having a light reflectance which is lower than a material of which the plurality of micromirrors are formed.

### BACKGROUND OF THE INVENTION

1. Field of the Invention

The present invention relates to a semiconductor device and a method of semiconductor fabrication, and more particularly, to a digital micromirror device and a method of fabricating the same.

2. Description of the Related Art

In accordance with digital lighting processing (DLP), a digital device is employed which blocks or passes, via a circuit plate, light reflected to a surface of a digital micromirror device, consisting of a plurality of micromirrors, in order to create an image. This image is created by adjusting the reflection angle of the micromirrors in response to a corresponding plurality of control signals. Products using DLP include projection televisions, projectors, and the like.

In the products using the DLP technique, each micromirror is used to produce one pixel of an image on a screen. The DLP products exhibit better performance when more light which is emitted from a light source, is reflected by a micromirror in an ON state and, impinges normally on a screen and when a lesser amount of the light emitted from the light source in a mirror OFF state, impinges on the screen.

A light reflection path which occurs in a conventional digital micromirror device and the problems associated with this conventional device will be described with reference to FIG. 1. Multiple micromirrors 110 are arranged in the digital micromirror device. As a reflection angle of each micromirror 110 is adjusted to reflect light, gaps are created between the micromirrors 110. A fixed base 100 of metal is therefore exposed to the light through each of the gaps. The light entering each of the gaps is partially scattered. The scattered light escapes from the gap and propagates toward a screen 120. Here, a portion of the exiting light impinges on the screen, producing a pixel value independent from an adjusted state of the micromirror. Accordingly, even though the micromirror 110 is in an OFF state, it tends to produce a pixel as if it were in an ON state.

In a conventional digital micromirror device, the fixed base 100 is formed of a metal such as aluminum, Ti/TiN/Al/TiN, or an alloy of Ti/TiN/AlCu/TiN and aluminum, which has a very high reflectance with respect to light. In order to reduce the amount of the reflected light in a conventional technology, it has been proposed to reduce the thickness of the TiN. There is, however, a limit to the amount of reflected light which can be reduced by changing the thickness of the TIN. Further, even though the micromirror is in the OFF state, it has a pixel value in the ON state on the screen, thereby degrading the contrast of a digital light processing (DLP) product using this type of digital micromirror device.

### SUMMARY OF THE INVENTION

The present invention is therefore directed to providing a digital micromirror device and a method of fabricating the same which are capable of enhancing the contrast of a digital light processing (DLP) product.

In accordance with one embodiment of the present invention, there is provided a digital micromirror device including a substrate having a plurality of electrodes which are each spaced apart at a predetermined interval; fixed bases having a predetermined height above a surface of the substrate and formed between the electrodes; and a plurality of micromirrors provided on the fixed bases and independently driven by an electrostatic force produced by the electrodes of the substrate for changing a reflection path of incident light to form an image; wherein the fixed bases comprise a material having a light reflectance which is lower than a material of which the plurality of micromirrors are comprised.

In this embodiment of the invention, the fixed bases can, by way of example, be formed of copper and the plurality of micromirrors can, by way of example, be formed of aluminum.

In accordance with another embodiment of the present invention, there is provided a method of fabricating a digital micromirror device, the method including depositing a first insulating layer, an electrode metal layer, and a first electrode etching photoresist on a substrate and then forming an electrode etching photoresist pattern using a first photolithographic and development process; etching the electrode metal layer using the electrode etching photoresist pattern to form electrodes; depositing a second insulating layer and a second photoresist on the electrodes and then forming a second photoresist pattern by performing photolithographic and development process; depositing a fixed lower metal layer and fixed lower etching photoresist using a third photoresist pattern and forming a third fixed lower etching photoresist pattern using a third photolithographic and development process; etching the fixed lower metal layer using the third fixed lower etching photoresist pattern to form fixed bases; depositing a fourth photoresist on the fixed bases and then forming a second photoresist pattern using a fourth photolithographic and development process; forming a micromirror metal layer and a fifth micromirror-metal-layer etching photoresist pattern; etching the micromirror metal layer to form a micromirror; and ashing the first photoresist pattern, the second photoresist pattern, and the micromirror-metal-layer etching photoresist pattern.

In accordance with this embodiment the method can comprise forming the fixed bases of a material which has a lower light reflectance than a material from which the plurality of micromirrors are formed. More specifically the method can comprise forming the fixed bases of copper. In addition the method can comprise forming the micromirrors of aluminum.

### BRIEF DESCRIPTION OF THE DRAWINGS

The above and other objects and features of the present invention will become apparent from the following description of preferred embodiments given in conjunction with the accompanying drawings, in which:

FIG. 1 is a cross-sectional view illustrating a reflection path of light in a conventional digital micromirror device;

FIGS. 2A to 2J are cross-sectional views illustrating a method of fabricating a digital micromirror device in accordance with an embodiment of the present invention; and

FIG. 3 is a cross-sectional view illustrating a reflection path of light in a digital micromirror device in accordance with an embodiment of the present invention.

### DETAILED DESCRIPTION OF THE PREFERRED EMBODIMENTS

Hereinafter, preferred embodiments of the present invention will be described in detail with reference to the accompanying drawings so that they can be readily implemented by those skilled in the art to which the present invention pertains.

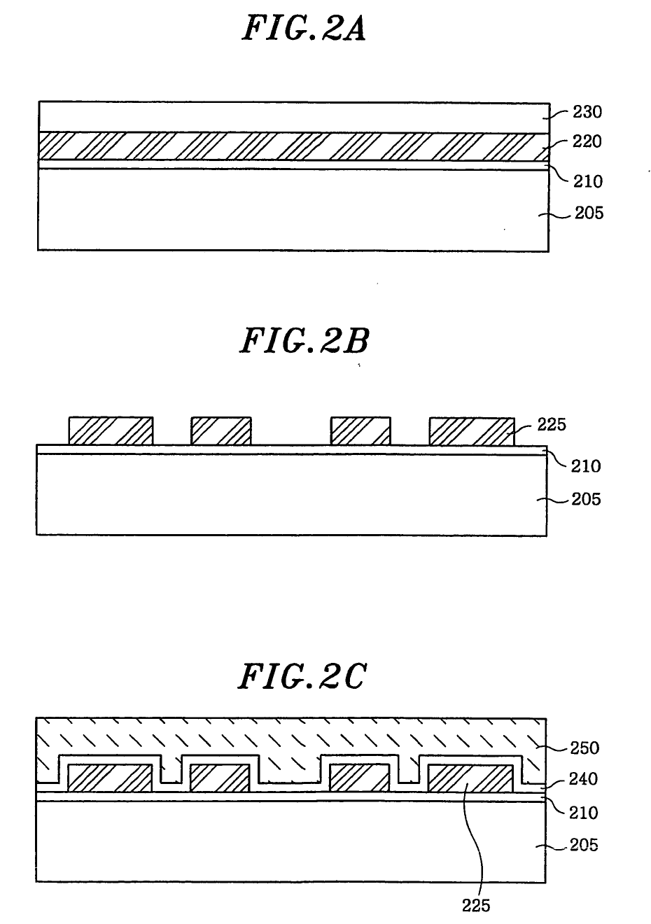

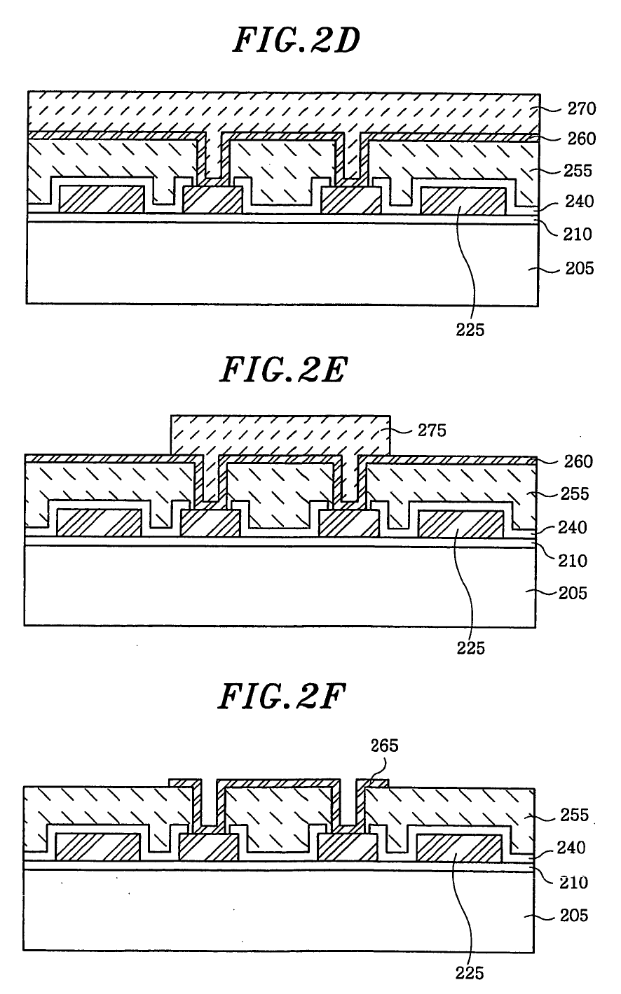

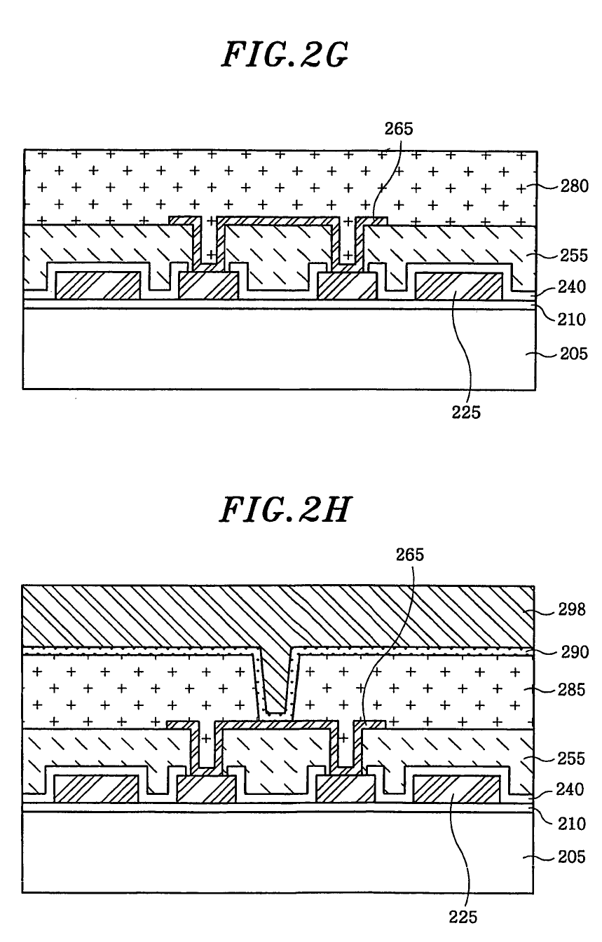

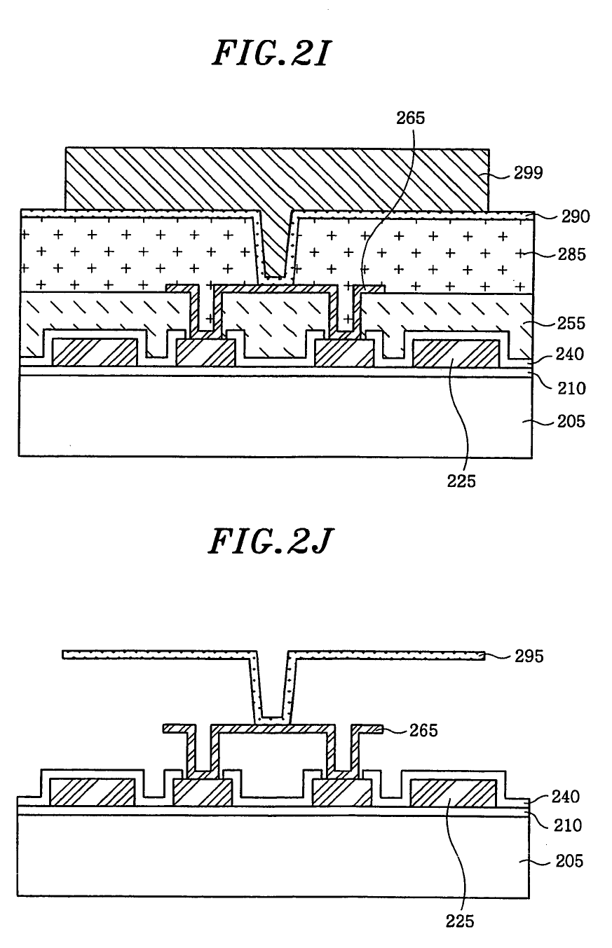

FIGS. 2A to 2J are cross-sectional views illustrating a method of fabricating a digital micromirror device 200 in accordance with an embodiment of the present invention.

First, a first insulating layer 210, an electrode metal layer 220, and an electrode etching photoresist (PR) 230 are sequentially deposited on a substrate 205, as shown in FIG. 2A. After the electrode etching photoresist pattern is formed by performing photolithographic and development processes, the electrode metal layer 220 is etched using the electrode etching photoresist pattern to form electrodes 225, as shown in FIG. 2B. The electrodes 225 are arranged at predetermined intervals on the substrate 205.

A second insulating layer 240 and a second photoresist 250 are deposited over the substrate 205 having the electrodes 225, as shown in FIG. 2C. A second photoresist pattern 255 is formed by performing photolithographic and development processes, and a fixed lower metal layer 260 and fixed lower etching photoresist 270 are deposited on the second photoresist pattern 255, as shown in FIG. 2D. The second photoresist pattern 255 has a shape that partially exposes the electrodes 225.

A third fixed lower etching photoresist pattern 275 is formed by performing photolithographic and development processes, as shown in FIG. 2E. The fixed lower metal layer 260 is then etched using the fixed lower etching photoresist pattern 275 as a mask to form a fixed base 265, as shown in FIG. 2F. A fourth photoresist 280 is deposited as shown in FIG. 2G. A fourth photoresist pattern 285 is formed by performing photolithographic and development processes, and a micromirror metal layer 290 and a fifth micromirror-metal-layer etching photoresist 298 are sequentially deposited on the fourth photoresist pattern 285, as shown in FIG. 2H.

A fifth micromirror-metal-layer etching photoresist pattern 299 is formed by performing photolithographic and development processes, as shown in FIG. 2I. The micromirror metal layer 290 is then etched using the photoresist pattern 299. Following this, the second photoresist pattern 255, the fourth photoresist pattern 285, and the fifth micromirror-metal-layer etching photoresist pattern 299 are removed using an ashing process to complete a digital micromirror device 200, as shown in FIG. 2J.

The digital micromirror device 200 includes a plurality of electrodes 225, a plurality of fixed bases 265, and a plurality of micromirrors 295, which are formed on the substrate 205. The micromirrors 295 are supported by the fixed bases 265, and the fixed bases 265 are connected to the electrodes 225. The micromirrors 295 are independently driven by an electrostatic force produced by the electrodes 225, to change the reflection path of incident light from the light source and form an image on the screen. Preferably, each micromirror 295 is formed of aluminum having high reflectance with respect to light. The fixed bases 265 are located on the electrodes 225 and are, in this embodiment, formed of copper. Copper has relatively lower reflectance with respect to light so that the light amount to be reflected toward the screen is reduced, thereby enhancing the contrast.

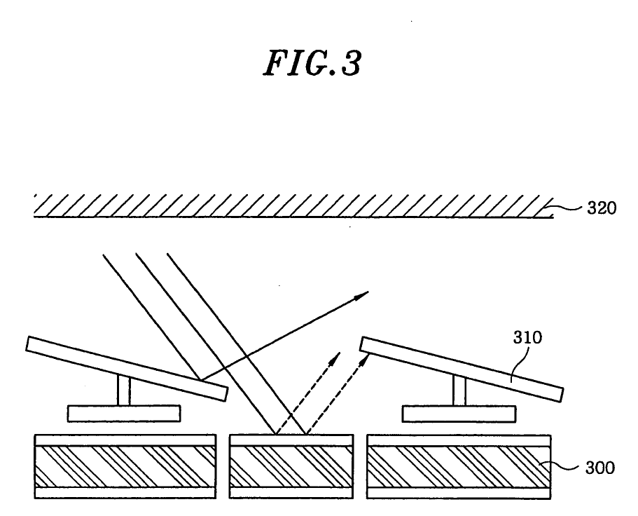

FIG. 3 is a cross-sectional view illustrating a reflection path of light in a digital micromirror device in accordance with an embodiment of the present invention. In the present invention, the fixed bases 300 are formed of copper rather than aluminum or an aluminum alloy, thereby reducing the amount of light reflected by the fixed base 300. This suppresses the degradation of OFF-state characteristics of the micromirrors 310, thereby enhancing the contrast of products using the digital micromirror device.

In accordance with the present invention, the fixed bases supporting the micromirrors of the digital micromirror device are formed of copper having very low reflectance, rather than aluminum or an aluminum alloy, thereby significantly reducing an amount of reflected and scattered light by presence of the fixed bases and thus reducing an amount of light incident to the screen. Thus, the performance of the digital micromirror device can be enhanced, and the contrast of DLP products using the digital micromirror device in accordance with the present invention can be enhanced.

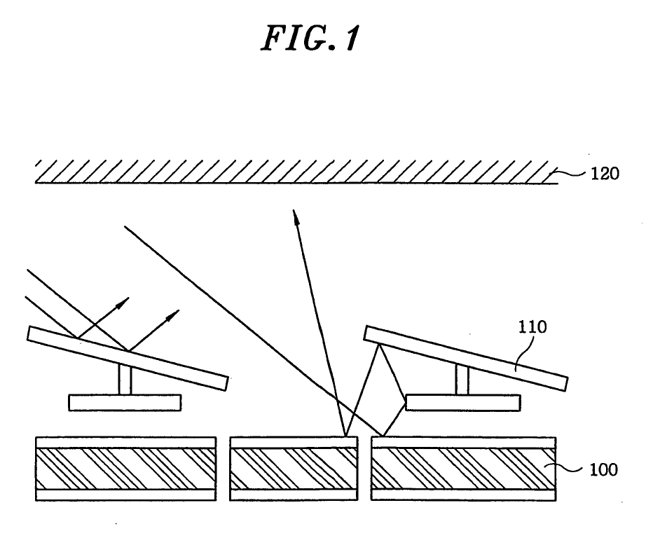

While the invention has been shown and described with respect to the preferred embodiments, it will be understood by those skilled in the art that various changes and modifications may be made without departing from the spirit and scope of the invention as defined in the following claims. For example, it is within the scope of the present invention to use materials other than aluminum and copper provided that one provides a high reflectance and the other a lower reflectance so as to attenuate the unwanted reflectance discussed in connection with FIG. 1.

What is claimed is:

1. A digital micromirror device comprising:
a substrate having a plurality of electrodes each spaced apart at a predetermined interval;
fixed bases having a predetermined height above a surface of the substrate and arranged between the electrodes; and
a plurality of micromirrors provided on the fixed bases and independently driven by an electrostatic force produced by the electrodes for changing a reflection path of incident light to form an image;
wherein the fixed bases comprise a material having a light reflectance which is lower than a material of which the plurality of micromirrors are comprised.

2. The digital micromirror device according to claim 1, wherein the fixed bases comprise copper.

3. The digital micromirror device according to claim 1, wherein the plurality of micromirrors comprise aluminum.

4. A method of fabricating a digital micromirror device, the method comprising:
depositing a first insulating layer, an electrode metal layer, and a first electrode etching photoresist, on a substrate;
forming an electrode etching photoresist pattern using a first photolithographic and development processes;
etching the electrode metal layer using the electrode etching photoresist pattern to form electrodes;
depositing a second insulating layer and a second photoresist on the electrodes and forming a second photoresist pattern using a second photolithographic and development processes;
depositing a fixed lower metal layer and fixed lower etching photoresist using a third photoresist pattern and forming a third, fixed lower etching photoresist pattern using a third photolithographic and development processes;
etching the fixed lower metal layer using the third, fixed lower etching photoresist pattern to form fixed bases;
depositing a fourth photoresist on the fixed bases and then forming a fourth photoresist pattern using a fourth photolithographic and development processes;
forming a micromirror metal layer and a fifth micromirror-metal-layer etching photoresist pattern;
etching the micromirror metal layer to form a micromirror; and
ashing the second photoresist pattern, the fourth photoresist pattern, and the fifth micromirror-metal-layer etching photoresist pattern.

5. The method according to claim 3, comprising forming the fixed bases of a material which has a lower light reflectance than a material from which the plurality of micromirrors are formed.

6. The method according to claim 5, comprising forming the fixed bases of copper.

7. The method according to claim 6, comprising forming the micromirrors of aluminum.
